(19) United States
(12) Patent Application Publication
(10) Pub. No.: US 2026/0149206 A1
(43) Pub. Date: May 28, 2026

(54) SYSTEMS FOR TRANSFERRING FLUID(S), ELECTRICITY, AND/OR SIGNAL(S) ACROSS A BOUNDARY AND PROCESSES FOR ASSEMBLING SAME

(71) Applicant: SOFEC, INC., Houston, TX (US)

(72) Inventor: Kevin Peter Minnock, Houston, TX (US)

(73) Assignee: SOFEC, INC., Houston, TX (US)

(21) Appl. No.: 19/399,691

(22) Filed: Nov. 25, 2025

Related U.S. Application Data
(60) Provisional application No. 63/724,420, filed on Nov. 25, 2024.

(51) Int. Cl. H01R 13/00; F16L 27/08

(52) U.S. Cl. CPC H01R 13/005; F16L 27/0804

(57) ABSTRACT

Systems for transferring fluid across a boundary between a first body rotatively coupled to a second body. The system can include first fluid and utility conduits on the first body, second fluid and utility conduits on the second body, and a swivel assembly including a fluid swivel, a utility swivel, a third fluid conduit in communication with the fluid swivel, and a third utility conduit in communication with the utility swivel. The system can include first and second connectors to connect the first fluid conduit to the fluid swivel and the second and third fluid conduits, first and second utility connectors to connect the first utility conduit to the utility swivel and the second and third utility conduits, a deployment frame coupled to the swivel assembly, and alignment guides having a first part on the second body and a second part on the deployment frame that engage with one another.

### CROSS-REFERENCE TO RELATED APPLICATION

This application claims priority to U.S. Provisional Patent Application No. 63/724,420, filed on Nov. 25, 2024, which is incorporated by reference herein.

### FIELD

Embodiments described generally relate to systems for transferring fluid(s), electricity, and/or signal(s) across a boundary and processes for assembling same. More particularly, such embodiments relate to systems for transferring a fluid via a fluid swivel and at least one of a fluid, electricity, and an optical signal via a utility swivel across a boundary between a first body rotatively coupled to a second body and processes for assembling same.

### BACKGROUND

In the drilling, production, and transportation of offshore oil and gas, mooring systems have been used to connect floating structures, e.g., floating production, storage, and offloading (FPSO) vessels, floating storage and offloading (FSO) vessels, barges, tankers, wind turbine support platforms, and other floating structures, to submerged rotatable mooring structures configured to moor the floating structure thereto while permitting the floating structure to rotate or weathervane about the mooring structure. The mooring structure includes a base structure fixed to a sea floor and a turntable that includes a fixed part rotatively coupled to a rotating part. The fixed part is coupled to the base structure and the rotating part is configured to connect to a mooring system that moors the floating structure thereto. Some conventional mooring systems are permanent, meaning the connected vessel, platform, or other floating structure can be maintained on location even in 100-year survival environmental conditions. Other conventional mooring systems are disconnectable, meaning the connected vessel, platform, or other floating structure can be disconnected and moved away from the mooring location to avoid severe weather events and conditions such as harsh seas, typhoons, hurricanes, and icebergs.

The submerged mooring structure includes a system for transferring fluid, electricity, and/or a signal across the boundary between the fixed part of the turntable and the rotating part of the turntable. Such system typically includes at least one fluid swivel and at least one utility swivel that each include a fixed part rotatively coupled to a rotating part. The fixed part of the fluid and utility swivels are coupled to the fixed part of the turntable and the rotating part of the fluid and utility swivels are configured to rotate with the rotating part of the turntable. The fluid and/or utility swivels from time to time must be brought to the surface for periodic maintenance, e.g., seal replacement. The current connections used to secure the fluid and utility swivels to the fixed part of the turntable are very time consuming to remove and replace, which leads to a long downtime in the transfer of fluids to and/or from the floating structure connected to the submerged mooring structure.

There is a need, therefore, for improved systems for transferring fluid(s), electricity, and/or signal(s) across a boundary between a first body rotatively coupled to a second body and processes for assembling same.

### SUMMARY

Systems for transferring fluid(s), electricity, and/or signal(s) across a boundary between a first body rotatively coupled to a second body and processes for assembling same are provided. In some embodiments, the system can include a first fluid conduit and a first utility conduit each disposed on the first body and a second fluid conduit and a second utility conduit each disposed on the second body. The system can also include a swivel assembly. The swivel assembly can include a fluid swivel that defines a fluid path therethrough and includes a fixed part rotatively coupled to a rotating part, a third fluid conduit in fluid communication with the fluid flow path defined by the fluid swivel, a utility swivel that defines a communications path therethrough and includes a fixed part rotatively coupled to a rotating part, and a third utility conduit in communication with the communication path defined by the utility swivel. The system can also include a first connector configured to connect the first fluid conduit and the fixed part of the fluid swivel to one another such that the first fluid conduit can be in fluid communication with the fluid flow path defined by the fluid swivel. The system can also include a second connector configured to connect the second fluid conduit and the third fluid conduit to one another such that the second fluid conduit can be in fluid communication with the third fluid conduit. The system can also include a first utility connector configured to connect the first utility conduit and the fixed part of the utility swivel to one another such that the first utility conduit can be in communication with the communication path defined by the utility swivel. The system can also include a second utility connector configured to connect the second utility conduit and the third utility conduit to one another such that the second utility conduit can be in communication with the third utility conduit. The system can also include a deployment frame configured to be coupled to the swivel assembly and a plurality of coarse alignment guides. Each coarse alignment guide can include a first part and a second part configured to engage with one another. The first part of each coarse alignment guide can be disposed on the second body and the second part of each coarse alignment guide can be disposed on the deployment frame. When the first fluid conduit and the fixed part of the fluid swivel are connected to one another via the first connector and when the second fluid conduit and the third fluid conduit are connected to one another via the second connector, the first fluid conduit, the fluid flow path defined by the fluid swivel, the second fluid conduit, and the third fluid conduit can maintain fluid communication with one another when the second body rotates relative to the first body. When the first utility conduit and the utility swivel are connected to one another via the first utility connector and when the second utility conduit and the third utility conduit are connected to one another via the second utility connector, the first utility conduit, the communication path defined by the utility swivel, the second utility conduit, and the third utility conduit can maintain communication with one another when the second body rotates relative to the first body.

In some embodiments, a process for assembling the system of the first embodiment can include measuring a relative angle between the first body and the second body. An orientation of the third fluid conduit, the rotating part of the fluid swivel, the third utility conduit, and the rotating part of the utility swivel can be adjusted relative to the fixed part of the fluid swivel and the fixed part of the utility swivel. The third fluid conduit, the third utility conduit, the swivel assembly, and the deployment frame can be deployed toward the first body and the second body. The first fluid conduit and the fixed part of the fluid swivel can be connected to one another via the first connector. The second fluid conduit and the third fluid conduit can be connected to one another via the second connector. The first utility conduit and the fixed part of the utility swivel can be connected to one another via the first utility connector. The second utility conduit and the third utility conduit can be connected to one another via the second utility connector.

In a second embodiment, the system of the first embodiment can further include a soft landing system and first and second fine alignment guides. Each fine alignment guide can include a first part and a second part configured to matingly engage with one another. The first part of the first fine alignment guide can be disposed on the first body. The first part of the second fine alignment guide can be disposed on the second body. The second part of the first fine alignment guide can be disposed on the fixed part of the fluid swivel or the fixed part of the utility swivel and can be configured to engage with the first part of the first fine alignment guide. The second part of the second fine alignment guide can be disposed on the third fluid conduit or the third utility conduit and can be configured to engage with the first part of the second fine alignment guide. When the first parts and the second parts of the coarse alignment guides are engaged with one another, the soft landing system can be configured to move the swivel assembly between a first position and a second position. When the swivel assembly is in the first position, the fixed part of the fluid swivel can be in a disconnected position relative to the first fluid conduit, the third fluid conduit can be in a disconnected position relative to the second fluid conduit, the fixed part of the utility swivel can be in a disconnected position relative to the first utility conduit, and the third utility conduit can be in a disconnected position relative to the second utility conduit. When the swivel assembly is in the second position, the fixed part of the fluid swivel can be in a connectable position relative to the first fluid conduit, the third fluid conduit can be in a connectable position relative to the second fluid conduit, the fixed part of the utility swivel can be in a connectable position relative to the first utility conduit, and the third utility conduit can be in a connectable position relative to the second utility conduit.

In some embodiments, a process for assembling the system of the second embodiment can include measuring a relative angle between the first body and the second body. An orientation of the third fluid conduit, the rotating part of the fluid swivel, the third utility conduit, and the rotating part of the utility swivel can be adjusted relative to the fixed part of the fluid swivel and the fixed part of the utility swivel. The third fluid conduit, the third utility conduit, the swivel assembly, and the deployment frame can be deployed toward the first body and the second body until the first part and the second part of each of coarse alignment guide are fully engaged with one another. The swivel assembly can be moved to the second position via the soft landing system such that the first fluid conduit can be in a connectable position relative to the fixed part of the fluid swivel, the second fluid conduit can be in a connectable position relative to the third fluid conduit, the first utility conduit can be in a connectable position relative to the fixed part of the utility swivel, and the second utility conduit can be in a connectable position relative to the third utility conduit. The first fluid conduit and the fixed part of the fluid swivel can be connected to one another via the first connector. The second fluid conduit and the third fluid conduit can be connected to one another via the second connector. The first utility conduit and the fixed part of the utility swivel can be connected to one another via the first utility connector. The second utility conduit and the third utility conduit can be connected to one another via the second utility connector.

### BRIEF DESCRIPTION OF THE DRAWINGS

The subject disclosure is further described in the detailed description that follows in reference to the drawings by way of non-limiting embodiments, in which like reference numerals represent similar parts throughout the embodiments shown in the drawings.

FIG. 1 depicts a side elevation view of an illustrative system for transferring fluid and electricity and/or a signal across a boundary between a first body rotatively coupled to a second body in a disengaged configuration, according to one or more embodiments described.

FIG. 2 depicts a plan view of the system shown in FIG. 1.

FIG. 3 depicts a side elevation view of the system shown in FIG. 1 in an engaged configuration.

FIG. 4 depicts another side elevation view of the system shown in FIG. 1 in an engaged configuration.

FIG. 5 depicts a side elevation view of another illustrative system for transferring fluid and electricity and/or a signal across a boundary between a first body rotatively coupled to a second body in a disengaged configuration, according to one or more embodiments described.

FIG. 6 depicts a plan view of the system shown in FIG. 5.

FIG. 7 depicts a side elevation view of the system shown in FIG. 5 in an engaged configuration.

FIG. 8 depicts another side elevation view of the system shown in FIG. 5 in an engaged configuration.

### DETAILED DESCRIPTION

A detailed description will now be provided. Each of the appended claims defines a separate invention, which for infringement purposes is recognized as including equivalents to the various elements or limitations specified in the claims. Depending on the context, all references to the “invention”, in some cases, refer to certain specific or preferred embodiments only. In other cases, references to the “invention” refer to subject matter recited in one or more, but not necessarily all, of the claims. It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the figures provided herein. This repetition is for the purpose of simplicity and clarity and does not in itself dictate a relationship between the various exemplary embodiments and/or configurations discussed in the Figures. Moreover, the formation of a first feature over or on a second feature in the description that follows includes embodiments in which the first and second features are formed in direct contact and also includes embodiments in which additional features are formed interposing the first and second features, such that the first and second features are not in direct contact. The exemplary embodiments presented below may be combined in any combination of ways, i.e., any element from one exemplary embodiment may be used in any other exemplary embodiment, without departing from the scope of the disclosure. The figures are not necessarily drawn to scale and certain features and certain views of the figures can be shown exaggerated in scale or in schematic for clarity and/or conciseness.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Also, the naming convention used herein is not intended to distinguish between components that differ in name but not function. Furthermore, in the following discussion and in the claims, the terms “including” and “comprising” are used in an open-ended fashion, and thus should be interpreted to mean “including, but not limited to.”

All numerical values in this disclosure are exact or approximate values (“about”) unless otherwise specifically stated. Accordingly, various embodiments of the disclosure may deviate from the numbers, values, and ranges disclosed herein without departing from the intended scope.

Further, the term “or” is intended to encompass both exclusive and inclusive cases, i.e., “A or B” is intended to be synonymous with “at least one of A and B,” unless otherwise expressly specified herein. The indefinite articles “a” and “an” refer to both singular forms (i.e., “one”) and plural referents (i.e., one or more) unless the context clearly dictates otherwise. The terms “up” and “down”; “upward” and “downward”; “upper” and “lower”; “upwardly” and “downwardly”; “above” and “below”; and other like terms used herein refer to relative positions to one another and are not intended to denote a particular spatial orientation since the apparatus and methods of using the same may be equally effective at various angles or orientations.

The terms “rotate”, “rotation”, “rotatable”, and “rotating” are used interchangeably and mean partial or unlimited rotation of a body about an axis of rotation.

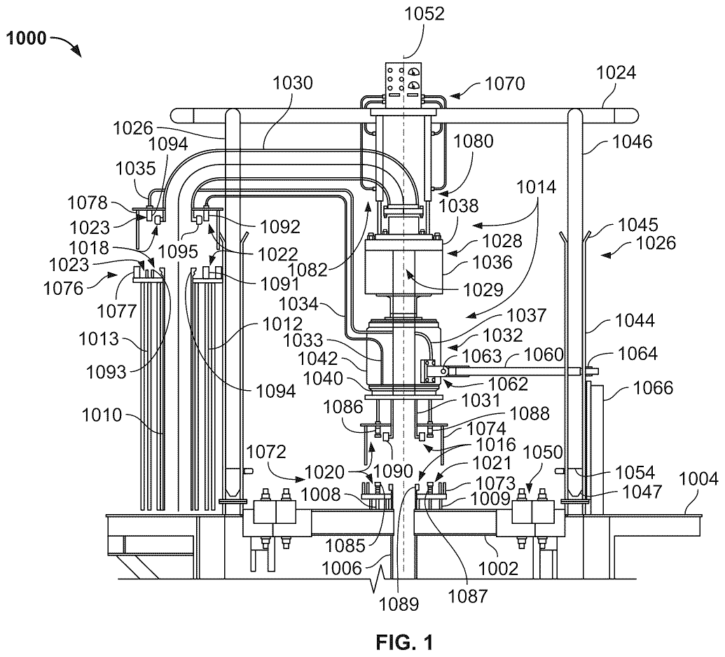

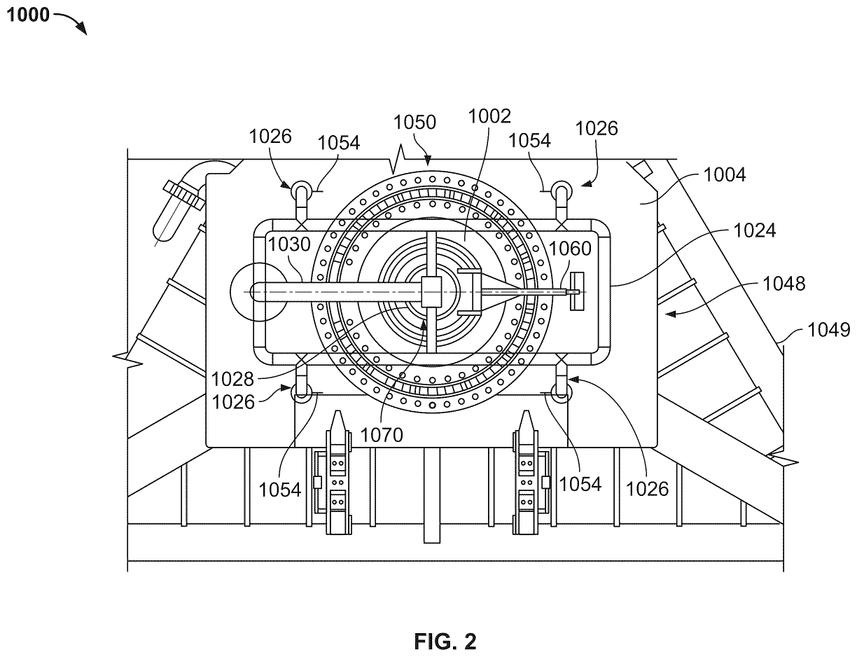

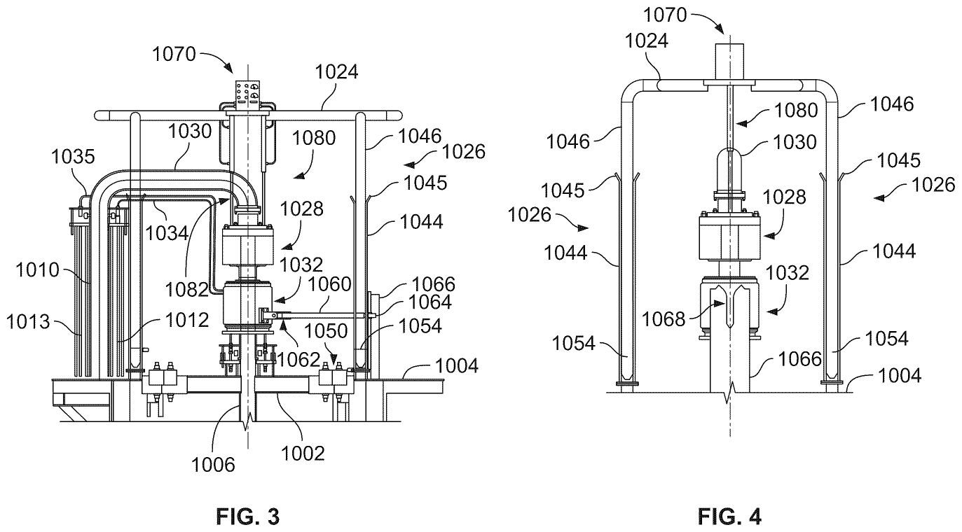

FIG. 1 depicts a side elevation view of an illustrative system 1000 for transferring fluid and electricity and/or signal(s) across a boundary between a first body 1002 rotatively coupled to a second body 1004 in a disengaged configuration, according to one or more embodiments. FIG. 2 depicts a plan view of the system 1000 shown in FIG. 1. FIG. 3 depicts a side elevation view of the system 1000 shown in FIG. 1 in an engaged configuration. FIG. 4 depicts another side elevation view of the system shown in FIG. 1 in an engaged configuration.

Referring to FIGS. 1-4 collectively, the system 1000 can include a first fluid conduit 1006, a first utility conduit (two are shown, 1008, 1009), a second fluid conduit 1010, a second utility conduit (two are shown, 1012, 1013), a swivel assembly 1014, a first connector 1016, a second connector 1018, a first utility connector (two are shown, 1020, 1021), a second utility connector (two are shown, 1022, 1023), a deployment frame 1024, and a plurality of coarse alignment guides 1026 (four are shown). The first fluid conduit 1006 and the first utility conduit(s) 1008, 1009 can each be disposed on the first body 1002. The second fluid conduit 1010 and the second utility conduit(s) 1012, 1013 can each be disposed on the second body 1004. The plurality of coarse alignment guides 1026 can be connected to the deployment frame 1024.

The swivel assembly 1014 can include a fluid swivel 1028, a third fluid conduit 1030, a utility swivel 1032, and a third utility conduit (two are shown, 1034, 1035). The fluid swivel 1028 can define a fluid path 1029 therethrough and can include a fixed part 1036 rotatively coupled to a rotating part 1038. The third fluid conduit 1030 can be in fluid communication with the fluid flow path 1029 defined by the fluid swivel 1028. In some embodiments, the fluid swivel 1028 can be a toroidal swivel or an inline swivel, an inline fluid swivel is shown. The utility swivel 1032 can define one or more communications paths (two are shown, 1033, 1037) therethrough and can include a fixed part 1040 rotatively coupled to a rotating part 1042. In some embodiments, the utility swivel 1032 can be a fluid swivel, an electrical swivel, a fiber-optic swivel, or a combination thereof. In some embodiments, the utility swivel 1032 can be configured as a toroidal swivel configured to permit a conduit 1031 that can be connected to and in fluid communication with the fluid path 1029 defined by the fixed part 1036 of the fluid swivel 1028 to pass through a center bore of the utility swivel 1032.

A fluid can be transferred across the boundary between the first body 1002 and the second body 1004 via the fluid swivel 1028 and at least one of a fluid, electricity, and an optical signal can be transferred across the boundary between the first body 1002 and the second body 1004 via the utility swivel 1032. In some embodiments, the fluid can be transferred from the first body 1002 and across the boundary to the second body 1004 via the fluid swivel 1028 or from the second body 1004 and across the boundary to the first body 1002 via the fluid swivel 1028. In some embodiments, the at least one of the fluid, electricity, and optical signal can be transferred from the first body 1002 and across the boundary to the second body 1004 via the utility swivel 1032 or from the second body 1004 and across the boundary to the first body 1002 via the utility swivel 1032. In some embodiments, the fluid swivel 1028 can transfer the fluid and the utility swivel 1032 can transfer the at least one of the fluid, electricity, and optical signal in the same direction or in opposite directions with respect to one another. In some embodiments, when the utility swivel 1032 includes two or more communications paths therethrough, each communications path can independently transfer the fluid, electricity, or optical signal from the first body 1002 and across the boundary to the second body 1004 or from the second body 1004 and across the boundary to the first body 1002. In some embodiments, the optical signal, if transferred through the utility swivel 1032, can have any desired wavelength. In some embodiments, the optical signal can have a wavelength of 850 nm, 1,300 nm, 1,310 nm, or 1,550 nm. In some embodiments, the optical signal can be transmitted via single-mode and/or multi-mode fiber cabling.

As shown in FIG. 1, the utility swivel 1032 can define a communications path that corresponds to the number of first utility conduits 1008, 1009 and to the number of second utility conduits 1012, 1013. The third utility conduits 1034, 1035 can be in communication with a corresponding communication path defined by the utility swivel 1032 for each of the first utility conduits 1008, 1009 and the second utility conduits 1012, 1013. More particularly, the third utility conduit 1034 can be in communication with the second utility conduit 1012 and a first communications path 1033 defined by the utility swivel 1032 that can also be in communication with the first utility conduit 1008 when the utility swivel 1032 is connected to the first utility conduit 1008. Similarly, the third utility conduit 1035 can be in communication with the second utility conduit 1013 and the second communications path 1037 defined by the utility swivel 1032 that can be in communication with the first utility conduit 1009 when the utility swivel 1032 is connected to the first utility conduit 1009.

As shown in FIGS. 1 and 2, in some embodiments, the first body 1002 can be a fixed part of a turntable 1048 and the second body 1004 can be a rotating part of the turntable 1048. The fixed part 1036 of the fluid swivel 1028 and the fixed part 1040 of the utility swivel 1032 can be disposed on or otherwise connected to the first body 1002. The rotating part 1038 of the fluid swivel 1028 and the rotating part 1042 of the utility swivel 1032 can be disposed on or otherwise connected to the second body 1004.

In some embodiments, the first body 1002 can be rotatively connected to the second body 1004 via a bearing arrangement 1050. The second body 1004 can be configured to rotate about a vertical or a substantially vertical axis 1052 (see FIG. 1) with respect to the first body 1002. The rotating part 1038 of the fluid swivel 1028 and the rotating part 1042 of the utility swivel 1032 can be secured to or otherwise disposed on the rotating part, e.g., the first body 1002, of the turntable 1048.

The bearing arrangement 1050 can be configured to allow the second body 1004 to rotate about the first body 1002. In some embodiments, the bearing arrangement 1050 can be configured to support an axial load, a horizontal load, and/or an overturning moment load. In some embodiments, the bearing arrangement 1050 can be or can include, but is not limited to, a plain bearing; a three-race roller bearing; a slewing bearing, e.g., a slow-rotating slew bearing with multi-race cylindrical rollers; a yaw bearing, e.g., a roller yaw bearing or a gliding yaw bearing. Bearing arrangements suitable for use in rotatively coupling the first body 1002 to the second body 1004 are well known to those skilled in the art.

In some embodiments, the first body 1002 can be configured to be disposed on or otherwise connected to a base structure 1049 that can be secured to a seabed. In some embodiments, the base structure 1049 can be disposed below a surface of a body of water and can be fixed or secured to the seabed with driven piles or suction piles. For example, the base structure can include one or more pile sleeves that can be disposed about one or more piles to fix or secure the base structure to the seabed. In other embodiments, the base structure can be a gravity-based structure. It should be understood that when the base structure is a gravity-based structure, in some embodiments, the base structure can maintain an acceptable orientation with respect to the seabed without requiring the base structure to include driven piles, suction piles, or the like. In some embodiments, the turntable 1048 can be configured to connect to a yoke of a submerged yoke mooring system. In such embodiments, a vessel can be moored to the turntable 1048 via the submerged yoke mooring system and can weathervane about the second body 1004 via the turntable 1048. Suitable submerged yoke mooring systems can include those described in U.S. Pat. Nos. 8,763,549; 11,738,828; 12,473,053; and U.S. Patent Application Publication No.: 2024/0326954.

In other embodiments, the base structure can include a tower or other elevated structure that can be secured to the seabed and the turntable 1048 can be located on the tower or other elevated structure at a location above the surface of the body of water. In such embodiments, a vessel can be moored to the turntable 1048 via a yoke mooring system that can be located above the surface of the body of water. Suitable yoke mooring systems that can include the turntable 1048 at a location above the surface of the body of water can include those described in U.S. Pat. Nos. 9,650,110; 11,267,532; 11,279,446; and 11,679,844.

The first connector 1016 can be configured to connect the first fluid conduit 1006 and the fixed part 1036 of the fluid swivel 1028 to one another such that the first fluid conduit 1006 can be in fluid communication with the fluid flow path 1029 defined by the fluid swivel 1028. For example, as shown in FIG. 1, the first connector 1016 can be configured to connect the first fluid conduit 1006 to the fixed part 1036 of the fluid swivel 1028 via the conduit 1031 that can extend from the fixed part 1036 of the fluid swivel 1028 and can be in fluid communication with the fluid flow path 1029 defined by the fluid swivel 1028. The second connector 1018 can be configured to connect the second fluid conduit 1010 and the third fluid conduit 1030 to one another such that the second fluid conduit 1010 can be in fluid communication with the third fluid conduit 1030. In some embodiments, the first connector 1016 and the second connector 1018 can each be configured as a hub and clamp connector. In some embodiments, the first connector 1016 and the second connector 1018 can independently be configured as a four bolt, a two bolt, or a single bolt hub and clamp connector. A suitable commercially available single bolt hub and clamp connector can include the Destec GSB Single Bolt Connector available from Destec Engineering LTD. Suitable four bolt hub and clamp connectors can include the four bolt GRAYLOC® clamp connector available from Oceaneering; the four bolt BlueSky Bluelock clamp connector available from Freudenberg; and the four bolt TPC clamp connector available from TP-Products.

The first utility connectors 1020, 1021 can be configured to connect the fixed part 1040 of the utility swivel 1032 and the first utility conduits 1008, 1009, respectively, to one another such that the first utility conduits 1008, 1009 can be in communication with the communication paths 1033, 1037, respectively, defined by the utility swivel 1032. The second utility connectors 1022, 1023 can be configured to connect the second utility conduits 1012, 1013 and the third utility conduits 1034, 1035, respectively, to one another such that the second utility conduits 1012, 1013 can be in communication with the third utility conduits 1034, 1035, respectively. The first and second utility connectors 1020/1021, 1022/1023 can be any suitable type of utility connectors. In some embodiments, the first and second utility connectors 1020/1021, 1022/1023 can be connectors that are typically referred to as hot stab and receptacle connectors. In some embodiments, the first and second utility connectors 1020/1021, 1022/1023 can be the DIGITRON®, ELECTRON®, and/or SPECTRON® connectors available from Siemens Energy. Other suitable utility connectors can include those available from Connector Subsea Solutions, Eaton, Parker, CRE, TE Connectivity, Subsea Design, RMSpumptools, TP-Products, and Ameriforge, to name a few.

In some embodiments, the deployment frame 1024 can be configured to be coupled to the swivel assembly 1014. The deployment frame 1024 can be configured to couple the rotating part 1038 of the fluid swivel 1028, the rotating part 1042 of the utility swivel 1032, the third fluid conduit 1030, the third utility conduits 1034, 1035, or a combination thereof to the second body 1004. The deployment frame 1024 can be configured to reduce a load acting on at least one of: the second fluid conduit 1010, the third fluid conduit 1030, the second utility conduits 1012, 1013, the third utility conduits 1034, 1035, the fluid swivel 1028, and the utility swivel 1032 when the deployment frame 1024 is coupled to the swivel assembly 1014 and the second body 1004 rotates relative to the first body 1002.

Each coarse alignment guide 1026 can include a first part 1044 and a second part 1046 that can be configured to engage with one another. The first part 1044 of each coarse alignment guide 1026 can be disposed on the second body 1004. The second part 1046 of each coarse alignment guide 1026 can be disposed on the deployment frame 1024. In some embodiments, the first part 1044 of the coarse alignment guide 1026 can be in the form of a tube or other structure that can define a bore or receptacle therein. In such embodiments, the second part 1046 of the coarse alignment guide 1026 can be in the form of a rod or a tube having a smaller diameter or cross-sectional area than the bore or receptacle defined by the first part 1044 of the coarse alignment guide 1026. In such embodiments, the first part 1044 can be configured to receive the first part 1046. As shown in FIG. 1, an end 1045 of the first part 1044 of the coarse alignment guide 1026 can define a frustoconical inner surface and an end 1047 of the second part 1046 of the coarse alignment guide 1026 can define a conical or frustoconical outer surface that can be configured to facilitate the alignment and insertion of the second part 1046 into the first part 1044. In other embodiments, the configuration of the first part 1044 and the second part can be reversed such that the second part 1046 can be configured to receive the first part 1044.

The first part 1044 and the second part 1046 of at least one of the coarse alignment guides 1026 can be secured to one another via one or more fasteners 1054. Suitable fasteners can be or can include, but are not limited to, R-clips, R-keys, bridge pins, hairpin cotter pins, spring cotter pins, screws, bolts, bolts and nuts, or any combination thereof. In some embodiments, the fasteners 1054 can be actuated via a person, i.e., a diver, or a remotely operated vehicle.

When the first fluid conduit 1006 and the fixed part 1036 of the fluid swivel 1028 are connected to one another via the conduit 1031 and the first connector 1016 and when the second fluid conduit 1010 and the third fluid conduit 1030 are connected to one another via the second connector 1018, the first fluid conduit 1006, the conduit 1031, the fluid flow path defined by the fluid swivel 1028, the second fluid conduit 1010, and the third fluid conduit 1030 maintain fluid communication with one another when the second body 1004 rotates relative to the first body 1002. When the first utility conduits 1008, 1009 and the utility swivel 1032 are connected to one another via the first utility connectors 1020, 1021, respectively, and when the second utility conduits 1012, 1013 and the third utility conduits 1034, 1035, respectively, are connected to one another via the second utility connectors 1022, 1023, respectively, the first utility conduits 1008, 1009, the communication paths 1033, 1037 defined by the utility swivel 1032, the second utility conduits 1012, 1013, and the third utility conduits 1034, 1035 maintain communication with one another when the second body 1004 rotates relative to the first body 1002.

In some embodiments, the swivel assembly 1014 can further include one or more torque arms (one is shown, 1060) that can include a first end 1062 connected to the rotating part 1042 of the utility swivel 1032 (shown) or the rotating part 1036 of the fluid swivel 1036 (not shown) and a second end 1064 configured to be connected to the second body 1004. For example, as shown in FIG. 4, the second end 1064 of the torque arm 1060 can be configured to engage with and be secured in a slot 1068 defined by a bracket 1066 that can be connected to and extend from the second body 1004. It should be understood that the second end 1064 of the torque arm 1060 can be configured to be connected to the second body 1004 via any type of connection. For example, in other embodiments, the second end 1064 of the torque arm 1060 can be configured to connect to the second body 1004 via connection to the deployment frame 1024 and/or one or more of the coarse alignment guides 1026. The torque arm 1060 can be configured to reduce a load acting on at least one of: the second fluid conduit 1010, the third fluid conduit 1030, the second utility conduits 1012, 1013, the third utility conduits 1034, 1035, the fluid swivel 1028, and the utility swivel 1032 when the torque arm 1060 is coupled to the swivel assembly 1014 and the second body 1004 and the second body 1004 rotates relative to the first body 1002.

In some embodiments, the first end 1062 of the torque arm 1060 can include a pivot point 1063 such that the torque arm 1060 can be folded upward toward the swivel assembly 1014 as the deployment frame 1024 along with the swivel assembly 1014, third fluid conduit 1030, and third utility conduits 1034, 1035 are lowered down toward the first and second bodies 1002, 1004 for connection thereto. For example, once the coarse alignment guides 1026 have been secured to the second body 1004, the torque arm 1060 can be rotated about the pivot point 1063 such that the second end 1064 of the torque arm 1060 moves into the slot 1068 defined by the bracket 1066.

In some embodiments, the system 1000 can also include a soft landing system 1070 and first and second fine alignment guides 1072, 1076. The first fine alignment guide 1072 can include a first part 1073 and a second part 1074 that can be configured to matingly engage with one another. The first part 1073 of the first fine alignment guide 1072 can be disposed on the first body 1002 and the second part 1074 of the first fine alignment guide 1072 can be disposed on the fixed part of the utility swivel 1032 (shown) or the fixed part of the fluid swivel 1028 (not shown) and can be configured matingly engage with the first part 1073 of the first fine alignment guide 1072. As shown, the first part 1073 of the first fine alignment guide 1072 can be configured to receive the second part 1074 of the first fine alignment guide 1072. In other embodiments, the second part 1074 of the first fine alignment guide 1072 can be configured to receive the first part 1073 of the first fine alignment guide 1072 (not shown).

The second fine alignment guide 1076 can include a first part 1077 and a second part 1078 that can be configured to matingly engage with one another. The first part 1077 of the second fine alignment guide 1076 can be disposed on the second body 1004 and the second part 1078 of the second fine alignment guide 1076 can be disposed on the third fluid conduit 1030, the third utility conduits 1034, 1035, or both the third fluid conduit 1039 and the third utility conduits 1034, 1035, as shown, and can be configured to engage with the first part 1077 of the second fine alignment guide 1076. As shown, the first part 1077 of the second fine alignment guide 1076 can be configured to receive the second part 1078 of the second fine alignment guide 1076. In other embodiments, the second part 1078 of the second fine alignment guide 1076 can be configured to receive the first part 1077 of the second fine alignment guide 1076 (not shown).

When the first parts 1044 and the second parts 1046 of the coarse alignment guides 1026 are engaged with one another, the soft landing system 1070 can be configured to move the swivel assembly 1014, the third fluid conduit 1030, and the third utility conduits 1034, 1035 between a first or disengaged position (shown in FIGS. 1 and 2) and a second or engaged position (shown in FIGS. 3 and 4). In some embodiments, the swivel assembly 1014, the third fluid conduit 1030, and the third utility conduits 1034, 1035 can be deployed or lowered to the first body 1002 and the second body 1004 while mounted or otherwise secured to the deployment frame 1024 with the soft landing system 1070 in the first position. In some embodiments, the first body 1002 and the second body 1004 can be disposed at a submerged location and the swivel assembly 1014, the third fluid conduit 1030, and the third utility conduits 1034, 1035 can be deployed or lowered to the first body 1002 and the second body 1004 while mounted or otherwise secured to or within the deployment frame 1024 with the soft landing system 1070 in the first position. In some embodiments, the soft landing system 1070 can be a hydraulically actuated, a pneumatically actuated, or a screw-jack actuated system to move the swivel assembly 1014, the third fluid conduit 1030, and the third utility conduits 1034, 1035 between the first or disengaged position and the second or engaged position. For example, as shown in FIGS. 1 and 3, the soft landing system 1070 can include one or more hydraulically or pneumatically actuated pistons (two are shown, 1080, 1082).

When the swivel assembly 1014, the third fluid conduit 1030, and the third utility conduits 1034, 1035 are in the first or disengaged position, the fixed part 1036 of the fluid swivel 1028 is in a disconnected position relative to the first fluid conduit 1006, the third fluid conduit 1030 is in a disconnected position relative to the second fluid conduit 1010, the fixed part 1040 of the utility swivel 1032 is in a disconnected position relative to the first utility conduits 1008, 1009, and the third utility conduits 1034, 1035 are in a disconnected position relative to the second utility conduits 1012, 1013. When the swivel assembly 1014 is in the second or engaged position, the fixed part 1036 of the fluid swivel 1028 is in a connectable position relative to the first fluid conduit 1006, the third fluid conduit 1030 is in a connectable position relative to the second fluid conduit 1010, the fixed part 1040 of the utility swivel 1032 is in a connectable position relative to the first utility conduits 1008, 1009, and the third utility conduits 1034, 1035 are in a connectable position relative to the second utility conduits 1012, 1013.

In some embodiments, the first and/or second fine alignment guides 1072, 1076 can be configured to rotate the rotating part 1038 of the fluid swivel 1028 and the third fluid conduit 1030 relative to the fixed part 1036 of the fluid swivel 1028 and to rotate the rotating part 1042 of the utility swivel 1032 and the third utility fluid conduits 1034, 1035 relative to the fixed part 1040 of the utility swivel 1032 as the soft landing system 1070 moves the swivel assembly 1014, the third fluid conduit 1030, and the third utility conduits 1034, 1035 from the first or disengaged position to the second or engaged position.

In some embodiments, the first part 1073 of the first fine alignment guide 1072 and/or the first part 1077 of the second fine alignment guide 1076 can include a conical or frustoconical surface similar to the end 1045 of the first parts 1044 of the coarse alignment guides 1026 (not shown). In some embodiments, the second part 1074 of the first fine alignment guide 1072 and the second part 1078 of the second fine alignment guide 1076 can include a conical or frustoconical outer surface (shown) at an end thereof that can be configured to facilitate the alignment and insertion of the second parts 1074, 1078 into the first parts 1073, 1077 of the first and second fine alignment guides 1072, 1076, respectively.

In some embodiments, when the first parts 1044 and the second parts 1046 of the coarse alignment guides 1026 are engaged with one another and the soft landing system 1070 is in the first or disengaged position, the first part 1073 of the first fine alignment guide 1072 can be partially aligned within the second part 1074 of the first fine alignment guide 1072 and the first part 1077 of the second fine alignment guide 1076 can be partially aligned with the second part 1078 of the second fine alignment guide 1076. In some embodiments, moving the swivel assembly 1014, the third fluid conduit 1030, and the third utility conduits 1034, 1035 from the first or disengaged position (shown in FIGS. 1 and 2) to the second or engaged position (shown in FIGS. 3 and 4) via the soft landing system 1070 can move a first part 1085 and a second part 1086 of the first utility connector 1020 into a connectable position, a first part 1087 and a second part 1088 of the first utility connector 1021 into a connectable position, a first part 1089 and a second part 1090 of the first connector 1016 in a connectable position, a first part 1091 and a second part 1092 of the second utility connector 1022, a first part 1093 and a second part 1094 of the second utility connector 1023, and a first part 1094 and a second part 1095 of the second connector 1018 into a connectable position.

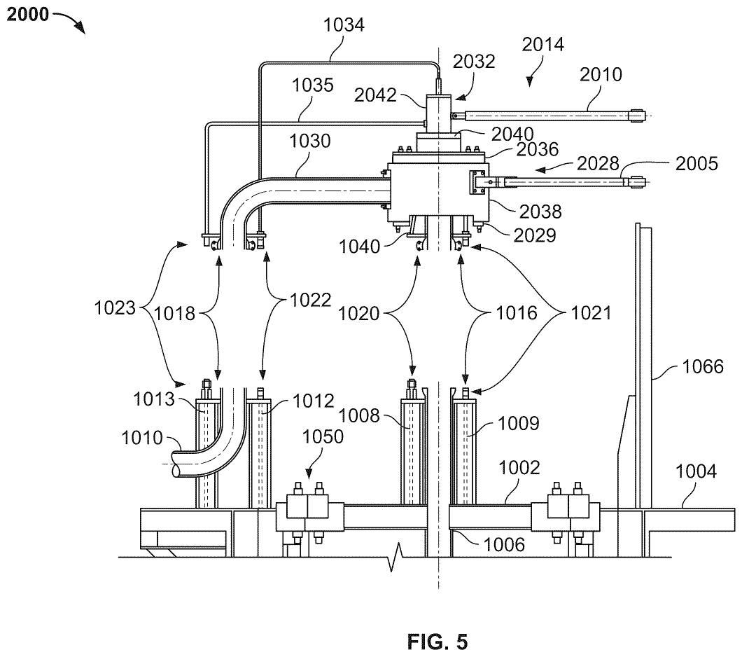

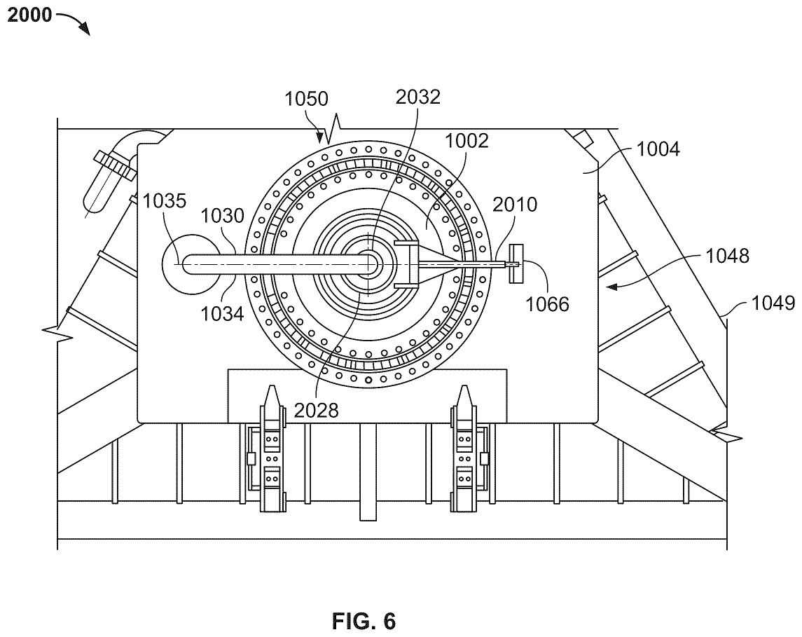

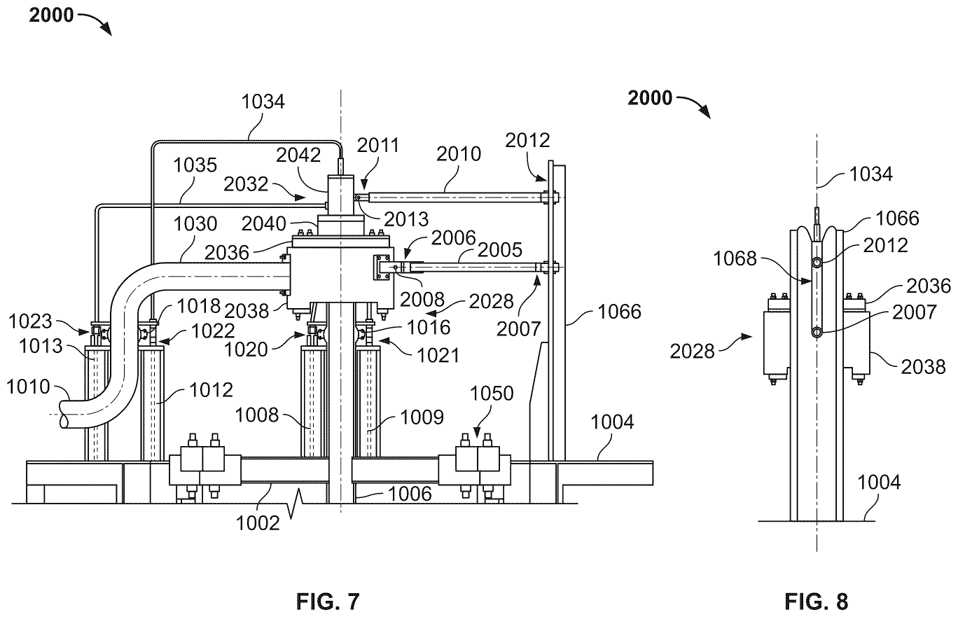

FIG. 5 depicts a side elevation view of another illustrative system 2000 for transferring fluid and electricity and/or a signal across a boundary between a first body 1002 rotatively coupled to a second body 1004 in a disengaged configuration, according to one or more embodiments. FIG. 6 depicts a plan view of the system 2000 shown in FIG. 5. FIG. 7 depicts a side elevation view of the system 2000 shown in FIG. 5 in an engaged configuration. FIG. 8 depicts another side elevation view of the system 2000 shown in FIG. 5 in an engaged configuration. Referring to FIGS. 5-8 collectively, the first body 1002 can be a fixed part of a turntable 1048, the second body 1004 can be a rotating part of the turntable 1048.

The system 2000 shown in FIGS. 5-8 can be similar to the system 1000 shown in FIGS. 1-4. One main difference between the system 2000 and the system 1000 is that the system 2000 can include a swivel assembly 2014 that can include a fluid swivel 2028 between a utility swivel 2032 and the first body 1002 instead of including the utility swivel 1032 between the fluid swivel 1028 and the first body 1002, as shown in the system 1000. Another difference between the system 2000 and the system 1000 is that that a rotating part 2038 of the fluid swivel 2028 can be located below a fixed part 2036 of the fluid swivel 2028 and a fixed part 2040 of the utility swivel 2032 can be located below the rotating part 2042 of the utility swivel 2032, which is opposite the arrangement shown in the system 1000.

The fluid swivel 2028 can be configured as a toroidal swivel that can allow the first and second utility conduits 1034, 1035 to pass through a central bore 2029 defined by the fluid swivel 2028 such that the utility swivel 2042 can be disposed above the fluid swivel 2028. The fixed part 2036 of the fluid swivel 2028 and the fixed part 2040 of the utility swivel 2032 can be disposed on or otherwise connected to the first body 1002. The rotating part 2038 of the fluid swivel 2028 and the rotating part 2042 of the utility swivel 2032 can be disposed on or otherwise connected to the second body 1004.

The system 2000 can include the first fluid conduit 1006, the first utility conduit (two are shown, 1008, 1009), the second fluid conduit 1010, the second utility conduit (two are shown, 1012, 1013), the swivel assembly 2014, the first connector 1016, the second connector 1018, the first utility connector (two are shown, 1020, 1021), and the second utility connector (two are shown, 1022, 1023). In some embodiments, the system 2000 can also include the bracket 1066 that can be disposed on the second body 1004 and can define the slot 1068 that can be configured to receive and secure one or more torque arms (two are shown, 2005, 2010) therein.

Although not shown, the second system 2000 can also include at least one of: the deployment frame 1024, the plurality of coarse alignment guides 1026, the first fine alignment guide 1072, the second fine alignment guide 1076, and the soft landing system 1070 shown in FIGS. 1-4. In some embodiments, the system 2000 can also include the deployment frame 1024, the plurality of coarse alignment guides 1026, the first fine alignment guide 1072, the second fine alignment guide 1076, and the soft landing system 1070 shown in FIGS. 1-4.

As shown, the first torque arm 2005 can have a first end 2006 connected to the rotating part 2038 of the fluid swivel 2028 and a second end 2007 configured to be connected to the second body 1004. For example, as shown in FIGS. 7 and 8, the second end 2007 of the first torque arm 2005 can be configured to engage with and be secured in the slot 1068 defined by the bracket 1066 that can be connected to and extend from the second body 1004. It should be understood that the second end 2007 of the first torque arm 2005 can be configured to be connected to the second body 1004 via any type of connection. For example, in other embodiments, if the deployment frame 1024 of the system 1000 is present, the second end 2007 of the first torque arm 2005 can be configured to connect to the second body 1004 via connection to the deployment frame 1024 and/or one or more of the coarse alignment guides 1026. The first torque arm 2005 can be configured to reduce a load acting on at least one of: the second fluid conduit 1010, the third fluid conduit 1030, the second utility conduits 1012, 1013, the third utility conduits 1034, 1035, the fluid swivel 2028, and the utility swivel 2032 when the system 2000 is assembled.

In some embodiments, the first end 2006 of the first torque arm 2005 can include a pivot point 2008 such that the first torque arm 2005 can be folded upward toward the swivel assembly 2014 as the swivel assembly 2014, third fluid conduit 1030, and third utility conduits 1034, 1035 are lowered down toward the first and second bodies 1002, 1004 for connection thereto. Once the swivel assembly 1014, third fluid conduit 1030, and third utility conduits 1034, 1035 have been lowered down into a connectable position, the first torque arm 2005 can be rotated about the pivot point 2008 such that the second end 2007 of the first torque arm 2005 moves into the slot 1068 defined by the bracket 1066.

As shown, the second torque arm 2010 can have a first end 2011 connected to the rotating part 2042 of the utility swivel 2032 and a second end 2012 configured to be connected to the second body 1004. For example, as shown in FIGS. 7 and 8, the second end 2012 of the second torque arm 2010 can be configured to engage with and be secured in the slot 1068 defined by the bracket 1066 that can be connected to and extend from the second body 1004. It should be understood that the second end 2012 of the second torque arm 2010 can be configured to be connected to the second body 1004 via any type of connection. For example, in other embodiments, if the deployment frame 1024 of the system 1000 is present, the second end 2012 of the second torque arm 2010 can be configured to connect to the second body 1004 via connection to the deployment frame 1024 and/or one or more of the coarse alignment guides 1026. Although not shown, in some embodiments, the second end 2012 of the second torque arm 2010 can be configured to connect to the second body 1004 via a second bracket that defines a second slot similar to the bracket 1068.

In some embodiments, the first end 2011 of the second torque arm 2010 can include a pivot point 2013 such that the second torque arm 2010 can be folded upward toward the swivel assembly 2014 as the swivel assembly 2014, third fluid conduit 1030, and third utility conduits 1034, 1035 are lowered down toward the first and second bodies 1002, 1004 for connection thereto. Once the swivel assembly 2014, third fluid conduit 1030, and third utility conduits 1034, 1035 have been lowered down into a connectable position, the second torque arm 2010 can be rotated about the pivot point 2013 such that the second end 2012 of the second torque arm 2010 moves into the slot 1068 defined by the bracket 1066.

In some embodiments, a process for assembling the system 1000 and/or 2000 can include measuring a relative angle between the first body 1002 and the second body 1004. An orientation of the third fluid conduit 1030, the rotating part 1038 or 2038 of the fluid swivels 1028, 2028, the third utility conduits 1034, 1035, and the rotating part 1042 or 2042 of the utility swivels 1032, 2032 relative to the fixed part 1036 or 2036 of the fluid swivels 1028, 2028 and the fixed part 1040 or 2040 of the utility swivels 1032, 2032. The third fluid conduit 1030, the third utility conduits 1034, 1035, and the swivel assemblies 1014, 2014 can be deployed or otherwise moved toward the first body 1002 and the second body 1004 into an engaged position. The first fluid conduit 1006 and the fixed part 1036 or 2036 of the fluid swivels 1028, 2028 can be connected to one another via the first connector 1016. The second fluid conduit 1010 and the third fluid conduit 1030 can be connected to one another via the second connector 1018. The first utility conduits 1008, 1009 and the fixed part 1040 or 2040 of the utility swivels 1032, 2032 can be connected to one another via the first utility connectors 1020, 1021, respectively. The second utility conduits 1012, 1013 and the third utility conduits 1034, 1035 can be connected to one another via the second utility connectors 1022, 1023, respectively.

In other embodiments, a process for assembling the system 1000 and/or 2000 can include measuring a relative angle between the first body 1002 and the second body 1004. An orientation of the third fluid conduit 1030, the rotating part 1038 or 2038 of the fluid swivels 1028, 2028, the third utility conduits 1034, 1035, and the rotating part 1042 or 2042 of the utility swivels 1032, 2032 can be adjusted relative to the fixed part 1036 or 2036 of the fluid swivels 1028, 2028 and the fixed part 1040 or 2040 of the utility swivels 1032, 2032. The third fluid conduit 1030, the third utility conduits 1034, 1035, and the swivel assembly 1014 or 2014 can be deployed toward the first body 1002 and the second body 1004 until the first part 1044 and the second part 1046 of each of the coarse alignment guides 1026 are fully engaged with one another. The third fluid conduit 1030, the third utility conduits 1034, 1035, and the swivel assembly 1014 or 2014 can be moved to the second or engaged position via the soft landing system 1070 such that the first fluid conduit 1006 can be in a connectable position relative to the fixed part 1036 or 2036 of the fluid swivels 1028, 2038, the second fluid conduit 1010 can be in a connectable position relative to the third fluid conduit 1030, the first utility conduits 1008, 1009 can be in a connectable position relative to the fixed part 1040 or 2040 of the utility swivels 1032, 2032, and the second utility conduits 1012, 1013 can be in a connectable position relative to the third utility conduits 1034, 1035. The first fluid conduit 1006 and the fixed part 1036 or 2036 of the fluid swivels 1028, 2028 can be connected to one another via the first connector 1016. The second fluid conduit 1010 and the third fluid conduit 1030 can be connected to one another via the second connector 1018. The first utility conduits 1008, 1009 and the fixed part 1040 or 2040 of the utility swivels 1032, 2032 can be connected to one another via the first utility connectors 1020, 1021. The second utility conduits 1012, 1013 and the third utility conduits 1034, 1035 can be connected to one another via the second utility connectors 1022, 1023.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim can be not defined above, it should be given the broadest definition persons in the pertinent art have given that term as reflected in at least one printed publication or issued patent. Furthermore, all patents, test procedures, and other documents cited in this application are fully incorporated by reference to the extent such disclosure can be not inconsistent with this application and for all jurisdictions in which such incorporation can be permitted.

While certain preferred embodiments of the present invention have been illustrated and described in detail above, it can be apparent that modifications and adaptations thereof will occur to those having ordinary skill in the art. It should be, therefore, expressly understood that such modifications and adaptations may be devised without departing from the basic scope thereof, and the scope thereof can be determined by the claims that follow.

What is claimed is:

1. A system for transferring fluid across a boundary between a first body rotatively coupled to a second body, comprising:
a first fluid conduit and a first utility conduit each disposed on the first body;
a second fluid conduit and a second utility conduit each disposed on the second body;
a swivel assembly comprising:
a fluid swivel that defines a fluid path therethrough, comprising a fixed part rotatively coupled to a rotating part;
a third fluid conduit in fluid communication with the fluid flow path defined by the fluid swivel;
a utility swivel that defines a communications path therethrough, comprising a fixed part rotatively coupled to a rotating part; and
a third utility conduit in communication with the communication path defined by the utility swivel;
a first connector configured to connect the first fluid conduit and the fixed part of the fluid swivel to one another such that the first fluid conduit is in fluid communication with the fluid flow path defined by the fluid swivel;
a second connector configured to connect the second fluid conduit and the third fluid conduit to one another such that the second fluid conduit is in fluid communication with the third fluid conduit;
a first utility connector configured to connect the first utility conduit and the fixed part of the utility swivel to one another such that the first utility conduit is in communication with the communication path defined by the utility swivel;
a second utility connector configured to connect the second utility conduit and the third utility conduit to one another such that the second utility conduit is in communication with the third utility conduit;
a deployment frame configured to be coupled to the swivel assembly; and
a plurality of coarse alignment guides, wherein:
each coarse alignment guide comprises a first part and a second part configured to engage with one another,
the first part of each coarse alignment guide is disposed on the second body,
the second part of each coarse alignment guide is disposed on the deployment frame,
when the first fluid conduit and the fixed part of the fluid swivel are connected to one another via the first connector and when the second fluid conduit and the third fluid conduit are connected to one another via the second connector, the first fluid conduit, the fluid flow path defined by the fluid swivel, the second fluid conduit, and the third fluid conduit maintain fluid communication with one another when the second body rotates relative to the first body, and
when the first utility conduit and the utility swivel are connected to one another via the first utility connector and when the second utility conduit and the third utility conduit are connected to one another via the second utility connector, the first utility conduit, the communication path defined by the utility swivel, the second utility conduit, and the third utility conduit maintain communication with one another while the second body rotates relative to the first body.

2. The system of claim 1, wherein the deployment frame is configured to couple the rotating part of the fluid swivel, the rotating part of the utility swivel, the third fluid conduit, the third utility conduit, or a combination thereof to the second body.

3. The system of claim 1, wherein the deployment frame is configured to reduce a load acting on at least one of: the second fluid conduit, the third fluid conduit, the second utility conduit, and the third utility conduit when the deployment frame is coupled to the swivel assembly and the second body rotates relative to the first body.

4. The system of claim 1, wherein the swivel assembly further comprises a torque arm having a first end connected to the rotating part of the fluid swivel or the rotating part of the utility swivel and a second end configured to connect to the second body.

5. The system of claim 4, wherein the torque arm is configured to reduce a load acting on at least one of: the second fluid conduit, the third fluid conduit, the second utility conduit, and the third utility conduit when the deployment frame is coupled to the swivel assembly and the second body rotates relative to the first body.

6. The system of claim 4, wherein the second end of the torque arm is configured to engage with and be secured in a slot defined by a bracket connected to and extending from the second body.

7. The system of claim 4, wherein the second end of the torque arm is configured to connect to the second body via connection to the deployment frame.

8. The system of claim 1, further comprising a soft landing system and first and second fine alignment guides, wherein:
each fine alignment guide comprises a first part and a second part configured to matingly engage with one another,
the first part of the first fine alignment guide is disposed on the first body,
the first part of the second fine alignment guide is disposed on the second body,
the second part of the first fine alignment guide is disposed on the fixed part of the fluid swivel or the fixed part of the utility swivel and is configured to engage with the first part of the first fine alignment guide,
the second part of the second fine alignment guide is disposed on the third fluid conduit or the third utility conduit and configured to engage with the first part of the second fine alignment guide, and
when the first parts and the second parts of the coarse alignment guides are engaged with one another, the soft landing system is configured to move the swivel assembly between a first position and a second position,
when the swivel assembly is in the first position, the fixed part of the fluid swivel is in a disconnected position relative to the first fluid conduit, the third fluid conduit is in a disconnected position relative to the second fluid conduit, the fixed part of the utility swivel is in a disconnected position relative to the first utility conduit, and the third utility conduit is in a disconnected position relative to the second utility conduit, and
when the swivel assembly is in the second position, the fixed part of the fluid swivel is in a connectable position relative to the first fluid conduit, the third fluid conduit is in a connectable position relative to the second fluid conduit, the fixed part of the utility swivel is in a connectable position relative to the first utility conduit, and the third utility conduit is in a connectable position relative to the second utility conduit.

9. The system of claim 8, wherein each first part of each fine alignment guide is configured as or comprises a frusto-conical alignment guide.

10. The system of claim 8, wherein the first and second fine alignment guides are configured to rotate the rotating part of the fluid swivel and the third fluid conduit relative to the fixed part of the fluid swivel and to rotate the rotating part of the utility swivel and the third utility fluid conduit relative to the fixed part of the utility swivel as the soft landing system moves the swivel assembly from the first position to the second position.

11. The system of claim 1, wherein the first connector and the second connector are each configured as a hub and clamp connector.

12. The system of claim 11, wherein the first connector and the second connector are each configured independently as a four bolt, a two bolt, or a single bolt hub and clamp connector.

13. The system of claim 1, wherein the fluid swivel comprises a toroidal swivel or an inline swivel.

14. The system of claim 1, wherein the utility swivel comprises a fluid swivel, an electrical swivel, a fiber-optic swivel, or a combination thereof.

15. The system of claim 8, wherein the soft landing system is a hydraulically actuated soft landing system, a pneumatically actuated soft landing system, or a screw-jack actuated soft landing system.

16. A process for assembling the system of claim 1, comprising:
measuring a relative angle between the first body and the second body;
adjusting an orientation of the third fluid conduit, the rotating part of the fluid swivel, the third utility conduit, and the rotating part of the utility swivel relative to the fixed part of the fluid swivel and the fixed part of the utility swivel;
deploying the third fluid conduit, the third utility conduit, the swivel assembly, and the deployment frame toward the first body and the second body;
connecting the first fluid conduit and the fixed part of the fluid swivel to one another via the first connector;
connecting the second fluid conduit and the third fluid conduit to one another via the second connector;
connecting the first utility conduit and the fixed part of the utility swivel to one another via the first utility connector; and
connecting the second utility conduit and the third utility conduit to one another via the second utility connector.

17. The process of claim 16, further comprising securing the first part and the second part of at least one coarse alignment guide to one another with one or more fasteners.

18. A process for assembling the system of claim 8, comprising:
measuring a relative angle between the first body and the second body;
adjusting an orientation of the third fluid conduit, the rotating part of the fluid swivel, the third utility conduit, and the rotating part of the utility swivel relative to the fixed part of the fluid swivel and the fixed part of the utility swivel;
deploying the third fluid conduit, the third utility conduit, the swivel assembly, and the deployment frame toward the first body and the second body until the first part and the second part of each of coarse alignment guide are fully engaged with one another;
moving the swivel assembly to the second position via the soft landing system such that the first fluid conduit is in a connectable position relative to the fixed part of the fluid swivel, the second fluid conduit is in a connectable position relative to the third fluid conduit, the first utility conduit is in a connectable position relative to the fixed part of the utility swivel, and the second utility conduit is in a connectable position relative to the third utility conduit;
connecting the first fluid conduit and the fixed part of the fluid swivel to one another via the first connector;
connecting the second fluid conduit and the third fluid conduit to one another via the second connector;
connecting the first utility conduit and the fixed part of the utility swivel to one another via the first utility connector; and
connecting the second utility conduit and the third utility conduit to one another via the second utility connector.

19. The process of claim 18, further comprising securing the first part and the second part of at least one coarse alignment guide to one another with one or more fasteners.
